(19) United States
(12) Patent Application Publication
(10) Pub. No.: US 2012/0306186 A1
(43) Pub. Date: Dec. 6, 2012

(54) AIRBAG FOR A VEHICLE PASSENGER-PROTECTING SYSTEM AND A METHOD FOR PRODUCING THE SAME

(75) Inventors: Christian WEYRICH, Elchingen (DE); Stefan SCHÄFER, Erbach (DE); Martin BREUNINGER, Neu-Ulm (DE); Volker RATHGEG, Ehingen-Risstissen (DE)

(73) Assignee: TAKATA AG

(21) Appl. No.: 13/525,022

(22) Filed: Jun. 15, 2012

Related U.S. Application Data
(63) Continuation of application No. PCT/EP2010/070243, filed on Dec. 20, 2010.

(30) Foreign Application Priority Data
Dec. 18, 2009 (DE) 10 2009 055 029.1

(51) Int. Cl. B60R 21/231; B32B 38/04; B32B 37/30

(52) U.S. Cl. 280/743.1; 156/60; 156/257

(57) ABSTRACT

An airbag device for a vehicle passenger-protecting system. According to one variant, the airbag device comprises a first airbag segment, which has at least two material blanks and a second airbag segment which has at least two material blanks, wherein the material blanks of the first airbag segment and the material blanks of the second airbag segment are connected to one another at the respective circumferential edge in a gas-tight manner. The first airbag segment has a first transitional section and the second airbag segment has a second transitional section, wherein the transitional sections form a transitional region in which the two airbag segments are connected to one another in a gas-tight manner. An opening can be formed in each of the two transitional sections.

### CROSS-REFERENCE TO RELATED PATENT APPLICATIONS

This application is a continuation of International Patent Application Number PCT/EP2010/070243, filed on Dec. 20, 2010, which was published in German as WO 2011/073445. The foregoing international application is incorporated by referenced herein.

### BACKGROUND OF THE INVENTION

The invention relates to airbag devices for a vehicle passenger-protecting system as well as a process for manufacturing an airbag device.

Airbag devices which protect the head of a vehicle occupant in the event of a crash, e.g. side impact, are known. In this case, the use of airbags is known which comprise two main fabric layers which are connected to one another at their circumferential edge using gas-tight stitching. When the airbag is inflated, one of the main layers of fabric is turned towards one or more of the passengers to be protected. The other layer supports itself in the inflated state of the airbag device for example on one or more lateral windows and/or on the lateral vehicle structure. Individual chambers or regions of an airbag can also be defined using gas-tight seams.

An airbag device for protecting vehicle occupants is known from WO 2009/056594 A1, comprising at least two segments which are disposed at a distance from one another and can be inflated using gas, and which in the inflated state each form an air cushion for a vehicle occupant to be protected. The inflatable airbag segments are manufactured separately, then stitched to one another at a connecting region. The airbag blank is thus produced from individual parts which are sewn to one another. A problem arising therefrom is that the airbag leaks at the seams of the individual parts. The aim is, however, to design the connection points of an airbag comprising several individual parts to be gas-tight so that, in the event of activation, the airbag can hold the resulting pressure for several seconds.

U.S. Pat. No. 6,805,374 B2 also describes an airbag device having several segments, wherein two airbag segments are joined to one another by a connecting hose.

US 2003/0205888 A1 describes an airbag device comprising several airbag segments which are connected to one another by hose-like connecting pieces. For the connection, one end of a hose-like connecting piece of this type is inserted as a whole into an airbag opening of an airbag segment and connected to the same.

### SUMMARY OF THE INVENTION

It is the underlying object of the present invention to provide airbag devices for a vehicle passenger-protection system, in which, in contrast to the prior art, material blanks are connected to one another to form an airbag device formed from several airbag segments in a different way or to form at least one main fabric layer of an airbag device. In addition, a method for producing an airbag device of this type is provided.

According to a first exemplary variant of the invention, in which an airbag device for a personal-protection system of a vehicle having two airbag segments, made in each case from at least two material blanks which are connected to one another in a gas-tight manner and which each form a transitional section, an opening is formed in each of the two transitional sections, and the two transitional sections lie superimposed one above the other with a lateral overlap with respect to the plane of extension of the airbag when the latter is laid out flat and are connected by an adhesive such that the opening formed in the first transitional section and the opening formed in the second transitional section form a sealed flow channel between the airbag segments.

A connection between two airbag segments thus occurs by a lateral joining of the airbag segments in one process step, without the need for a stitching procedure in order to provide a connection channel between the two airbag segments. The joining direction is lateral in the sense that two transitional sections of the airbag segments lie one above the other with a lateral overlap with respect to the plane of extension of the airbag when the latter is laid out flat, wherein the openings formed in the respective transitional sections form a sealed flow channel between the airbag segments.

This solution effectively and quickly enables the connection of two airbag sections since pre-fabricated airbag segments can be connected to one another in one process step, using an adhesive, and providing a flow channel between the airbag segments.

One exemplary embodiment of the invention provides that the two transitional sections of the airbag segments lie one above the other with a lateral overlap with respect to the plane of extension of the airbag when the latter is laid out flat such that the opening formed in the first transitional section and the opening formed in the second transitional section lie directly on top of one another and are thereby sealed by the adhesive, such that a sealed flow channel is provided between the two airbag segments. The two airbag segments are thus laterally joined in such a way that the openings in the two airbag segments lie directly on top of one another in the two sections.

Provision can be made that openings are formed in one of the material blanks of the respective airbag segment in each case. In the state in which the airbag is laid out flat, for example, the opening is formed by a slit or an incision in a material blank of the respective airbag segment. However, other types of openings are also possible, for example a circular or oval opening.

Provision is made in a further exemplary embodiment that in the state in which the airbag is laid out flat, the transitional region comprises:

a first and a second material blank of the first airbag segment, wherein the first material blank has a first region, and the second material blank has a second region, which are arranged on top of one another and are connected to one another at the circumferential edge of said material blanks in a gas-tight manner, and wherein an opening in the material blank is formed in the upper of the two regions,

a third and a fourth material blank of the second airbag segment, wherein the third material blank has a third region, and the fourth material blank has a fourth region, which are arranged on top of one another and are connected to one another at the circumferential edge of said material blanks in a gas-tight manner, and wherein an opening in the material blank is formed in the lower of the two regions,

wherein the four regions of the two airbag segments are arranged on top of one another in the transitional region in such a way that the opening in the lower of the two regions of the second airbag segment is placed above the opening in the upper of the two regions of the first airbag segment.

In this way, a transitional region is formed in which the four aforementioned regions of the material blanks are arranged on top of one another in the state in which the airbag is laid out flat. In one embodiment, said indicated regions are formed at the front end of a hose-shaped region or channel formed by the two airbag segments.

It is thus provided in one inventive embodiment that at least one of the airbag segments forms a hose-like region which—in relation to the state of the airbag device in the state when installed in a vehicle—has a lower vertical expansion along the vertical vehicle axis than the remaining part of the airbag segment under consideration, and the transitional sections are formed in the region formed in a hose-like way.

In a further exemplary embodiment, both airbag segments have, in respect to the plane of extension when the airbag is laid out flat, two fabric layers with offset ends in the transitional section. During the lateral joining, two such fabric layers are laid one above the other with a lateral overlap and connected to one another in an overlapping region, wherein in each case two fabric layers connected in such a way form one of the main fabric layers of the airbag. The openings, which form a flow channel after the airbag segments have been connected, are in each case a front opening between the offset ends of the fabric layers.

Reference is made to the fact that the two airbag segments under consideration do not both have to serve as passenger protection. It can thus be provided that at least one of the airbag segments represents a connecting segment, that two airbag segments connected to one another serve to protect vehicle occupants. It can be further provided that the gas from a gas generator flows into a connecting segment of this type in the case of activation or a gas generator is disposed in a connecting segment of this type and gas is supplied from the connecting segment into one or more airbag segments which serve to protect the vehicle occupants.

According to a second exemplary variant of the invention of the airbag device, that for two main fabric layers of the airbag device, which layers comprise separate material blanks, in each case at least one material blank has at least one connecting region which overlaps with a connecting region of another material blank of the same main fabric layer, and the material blanks are connected to one another in the overlapping region exclusively by means of an adhesive in a gas-tight manner. It is further provided that at least one overlapping region of the first main fabric layer is offset and/or runs at an angle to all overlapping regions of the second main fabric layer.

This inventive solution likewise provides a gas-tight, and thereby improved configuration of the connection of the material blanks. Said material blanks are inventively no longer stitched in the connecting regions thereof, but rather glued to one another. The adhesive used in this case is preferably a fast setting adhesive which cures in particular within 10 minutes or less, in particular within one minute. The fast curing prevents an otherwise necessary waiting time during the further production of the airbag device, and enables material blanks which have been glued to one another to loop immediately into the further production process. A silicon adhesive is used for example as the adhesive.

This inventive variant also involves a lateral joining of the material blanks which are laid one over the other, with a lateral overlap with respect to the plane of extension of the airbag when the latter is laid out flat, and glued. In so doing, two material blanks are connected to one another by forming an overlapping region, which respectively form a main fabric layer in the finished airbag.

The application of an adhesive is provided for joining two material blanks of the airbag device, either exclusively or with the additional use of stitching. The adhesive is thereby applied between two connecting regions, which are lying flat, of the material blanks to be connected. The adhesive, gas-tight connection takes place in the overlapping region formed thereby. The fabric layers lie directly above one another in the overlapping region.

Due to the feature that at least one overlapping region of the first main fabric layer is offset from and/or runs at an angle to all overlapping regions of the second main fabric layer (which includes the case in which all overlapping regions in the first main fabric layer are offset from and/or run at an angle to all the overlapping regions of the second main fabric layer), a material accumulation, which occurs due to overlapping regions superimposed in the two main fabric layers, is prevented to the greatest extent. Another advantage comprises the improved possibility of realizing adhesive seams in the two main fabric layers in only one process step, due to the offset or angled arrangement. Reference is made to that fact that an offset is to be understood not only as a parallel offset, but as any type of offset. An angled arrangement can include straight or curved arrangements.

Reference should be made to the fact that the second inventive variant provides an adhesive joining of one or more material blanks from the same main fabric layer. In the event that the airbag device is filled with gas, connections of this type within one main fabric layer are loaded in a shearing manner, i.e. the forces applied are mainly shearing forces which effect the airbag material in the plane of the main fabric layer. A distinction must be made from circumferential seams and functional seams in the two main fabric layers, which latter seams prevent a separation of these layers from one another in the case of load, and are loaded with peeling forces, i.e. primarily forces running perpendicular to the plane of the main fabric layers. Circumferential seams are thereby seams that connect the circumferential edges of the main fabric layers to one another in a gas-tight manner. Functional seams are seams which connect the two main fabric layers to one another in order to form different chambers or regions in an airbag device.

These circumferential and functional seams can be formed for example by combining a silicon track with a seam running through the middle thereof in a gas-tight manner. The formation of a gas-tight seam using both a silicon track and a seam is relatively expensive. It should also be noted that silicon materials which are suitable for providing a silicon track of this type are provided as 2-component silicon which undergoes a cold vulcanization which generally lasts 10 hours or more. It is thus time-intensive to apply these circumferential and functional seams, and as such cannot be quickly looped into the further production process of an airbag device.

The airbag device and the connection technology used therein to connect individual material blanks in order to form a cohesive main fabric layer can be used for air cushions in which the main fabric layers are formed by separate layers that are sewn to one another along their circumference, as well as for airbags in which the main fabric layers are superimposed in a butterfly design. In a butterfly design, a one-piece airbag part, which is inventively formed from material blanks glued to one another, is folded along at least one folding edge, whereby the two main fabric layers are generated. In addition, the main fabric layers are glued to one another in the edge regions which are not formed by the folding edge. A mixed connection of one-piece and multi-piece embodiments can also be provided. For example, a first airbag segment can be formed in a butterfly design, while a second airbag segment, to be connected to the first, is formed by two separate layers.

It is applicable to all inventive variants and embodiments that the individual material blanks typically consist of woven fabrics, particularly nylon (polyamide), which is coated on the inner side of the material blank to reduce air permeability, for example, provision is made for a silicon coating. The adhesive used for the adhesive connection of individual material blanks is formed for this case such that it adheres well to both the coated side and the uncoated side of the fabric layer. In other embodiments, provision can be made that the material blanks are made from non-wovens, e.g. fleece, knitted materials, laminates or a single or multi-layered film.

In an exemplary embodiment of the second inventive variant, the first and the second main fabric layers form at least two pre-fabricated, inflatable airbag segments separated from one another, which are glued to one another in a gas-tight manner. In this variant, individual airbag segments are initially pre-fabricated using known, standard production methods, and said segments are only connected to one another in a terminal production step at the respective connecting regions and/or connecting points via an adhesive connection. The individual airbag segments can thereby again respectively comprise individual material blanks glued to one another, or alternatively only one individual material blank in butterfly design, or mixed forms.

Reference is made to the fact that two inflatable airbag segments to be connected to one another can be formed such that both airbag segments in the inflated state each form an air cushion for a vehicle occupant to be protected. However, it is also possible that one of the airbag segments only serves to connect one airbag segment to a further third airbag segment. An airbag segment of this type serving as a connection or as a filling channel is indeed likewise inflatable; however, it does not primarily serve to protect the vehicle occupant.

In one exemplary embodiment of the second inventive variant, it is provided that two airbag segments glued to one another each have a connecting region from the first main fabric layer, and a connecting region from the second main fabric layer, which are offset from one another when the airbag segment is laid out flat. The respectively offset connecting regions allow the adhesion of two airbag segments to one another in one single process step, in which the connecting regions of the first main fabric layers as well as the connecting regions of the second main fabric layers are glued to one another in one step.

In order to concretely achieve this, provision can be made that, for example, one airbag segment forms a first connecting region of the first main fabric layer and additionally an offset second connecting region to the second main fabric layer. The other airbag segment likewise forms a third connecting region to the first main fabric layer, and additionally an offset fourth connecting region to the second main fabric layer. The two connecting regions of a main fabric layer are each then adhesively connected to one another. Due to the offset provided, this can take place in one process step.

Provision is made in another embodiment that at least one of the airbag segments forms a hose-like region which—in relation to the state of the airbag device in the state when installed in a vehicle—has a lower vertical expansion along the vertical vehicle axis than the remaining part of the airbag segment under consideration. The connecting regions for connecting the airbag segment with another airbag segment are formed in the hose-shaped region. An embodiment of an airbag segment of this type enables a connecting channel for connecting with another airbag segment and/or a filling channel for providing an accommodation for a gas generator.

This enables two inflatable airbag segments, each forming an air cushion for a vehicle occupant to be protected, to be connected to one another via a connecting region, which is not formed as a separate airbag segment, but rather is formed by the hose-like partial regions of the two relevant airbag segments. However, in alternative embodiments, a separate airbag segment may be provided for connecting two airbag segments respectively serving as air cushions.

Provision is made in a further exemplary inventive embodiment that the inflatable airbag segments are glued to one another in the already folded state. In this case, provision can be particularly made that a final joining of the airbag segments to form a complete airbag by gluing the respective connecting regions only takes place after the individual airbag segments have been folded, and the fold has been set. In this case, provision can be made that the partly pre-folded airbag segments are each integrated in a sheathing, e.g. a flexible fabric sleeve. An embodiment of this type takes place if, for example, different folding techniques are used to fold the individual airbag segments. Provision can be made, for example, that a first partial region of the airbag segments is folded by roll folding. The individual airbag segments are subsequently joined to create a complete airbag. Afterwards, the complete airbag is subsequently fully folded, e.g. using zigzag folds for the airbag material not yet folded.

Provision is made in a further exemplary embodiment that the overlapping region of two material blanks is provided with at least one safety or positioning seam. Said seam runs for example substantially perpendicular to the overlapping region. The safety or positioning seam provides additional protection against peeling forces and/or pre-fixing before the complete setting of the adhesive. Provision can be particularly made that at least one safety or positioning seam is formed in the region in which two inflatable airbag segments are glued to one another. Provision can be further made that the safety or positioning seam penetrates the material layers of both the first main fabric layer and second main fabric layer.

As already mentioned, the adhesive used is for example a silicon adhesive. Provision is made in one embodiment that the silicon adhesive be made from a paste-like blank of an adhesive compound. The blank is applied to one of the respectively involved connecting regions prior to the gluing. By providing defined blanks of adhesive compound, the production process can be further simplified and accelerated. In an alternative variant, the adhesive is applied in a viscous state to a blank. Provision can be further made for all adhesives, particularly paste-like, firm silicon adhesives, that the setting process be accelerated or initiated by applying contact pressure and/or heat.

In one exemplary embodiment of the present invention, the airbag device is an airbag device to protect the head of a vehicle occupant during a side impact, wherein the airbag device forms at least two gas-inflatable segments which, in the inflated state, each create an air cushion for a vehicle occupant to be protected. For example, the respective air cushions extend in front of a side window of a vehicle. Correspondingly, the second main fabric layer in an embodiment of this type extends, when the airbag device is inflated, at least partially in front of a side window and/or side vehicle frame of a vehicle. The first main fabric layer is disposed opposite the second main fabric layer, and, when the airbag is inflated, faces towards one or more passengers to be protected.

The invention further relates to methods for producing an airbag device. A first exemplary method variant for producing an airbag device has the following steps:

Provision of at least two pre-fabricated, inflatable airbag segments, separated from one another, wherein each of the airbag segments has a first and a second material layer, which, in the fully assembled airbag device, form parts of a first and a second main fabric layer of the airbag device, and wherein each of the material layers has a connecting region such that the connecting regions of an airbag segment are offset from one another when the segment is laid out flat, and

Connection of the airbag segments by simultaneously connecting the connecting regions of the first main fabric layer and the connecting regions of the second main fabric layer by means of an adhesive.

In this method variant, individual airbag segments each containing at least one material layer of the first main fabric layer and at least one material layer of the second main fabric layer are pre-fabricated using standard production methods, and subsequently glued to one another at the respective connecting regions via an adhesive connection. This method variant enables thereby the simultaneous connection in one process step of the rear material layers of two airbag segments to be connected to one another as well as the front material layers of said airbag segments.

Provision is already made in one embodiment of this method variant that the adhesive is initially applied simultaneously to a connecting region on the inner side of the rear main fabric layer and to a connecting region on the outer side of the front main fabric layer of a first airbag segment that is laid flat or partly pre-folded. Subsequently, a connecting region of the outer side of the rear main fabric layer and a connecting region of the inner side of the front main fabric layer of the adjacent, airbag segment that is laid flat or partly pre-folded is laid on top of the corresponding connecting regions and the adhesive of the first airbag segment. Due to the respective offset, the airbag segments can be glued to one another in this way in a single process step.

A second exemplary method variant for producing an airbag device has the following steps:

Connection of two material blanks to form a first inflatable airbag segment, wherein a first opening is created in one of the material blanks in a region that forms the transitional section of the airbag segment, through which opening gas can flow out of the first airbag segment or into said segment,

Connection of two more material blanks to form a second inflatable airbag segment, wherein a second opening is created in one of the material blanks in a region that forms the transitional section of the airbag segment, through which opening gas can flow out of the second airbag segment or into said segment,

Connection of the first and second airbag segments by means of an adhesive, wherein the transitional sections of the two airbag segments are laid one above the other with a lateral overlap with respect to the plane of extension of the airbag when the latter is laid out flat such that the openings formed in the two airbag segments create a flow channel.

In order to form a flow channel, the openings formed in the two airbag segments are placed directly on top of one another in one embodiment.

Provision is made in another exemplary embodiment that the adhesive is applied around one of the openings and on the relevant adjacent material blank abutting said opening before the transitional sections of the two airbag segments are laid one above the other with lateral overlapping such that the openings formed in the two airbag segments are placed above one another.

Overall, the invention provides sealed airbag devices composed of individual material blanks and which, due to the possibility of using a plurality of material blanks to form the individual airbag segments and/or the first and second main fabric layers, generate less waste scrap and are thus inexpensive to manufacture. At the same time, the inventive solution is cheap in terms of production, as no additional seams are needed to connect the individual material blanks.

A preferred application consists of the provision of an airbag device for head protection, which extends along the lateral structure of a vehicle. However, the invention can be fundamentally used for any airbag device, e.g. for airbag devices, which are designed on the outer shell of a vehicle to protect pedestrians.

### BRIEF DESCRIPTION OF THE DRAWINGS

The invention is described in more detail below with reference to the Figures in the drawing by way of a plurality of embodiments:

FIG. 1 shows an embodiment of an airbag device comprising two airbag segments to be glued to one another.

FIG. 2 shows detail X of the airbag device from FIG. 1, wherein FIG. 2 shows an enlarged view of the connecting regions of the two airbag segments to be joined.

FIG. 3 shows the connecting regions of the airbag segments in FIGS. 1, 2, wherein an additional annular adhesive application is shown on one airbag segment.

FIG. 4 shows the connecting regions of the airbag segments from FIG. 3 are glued to one another.

FIG. 5 shows a sectional diagram of the adhesive connection and the connecting regions involved from FIG. 4.

FIG. 6 shows the connecting regions of the airbag segments from FIGS. 1, 2, wherein an adhesive is additionally applied flat across the one airbag segment.

FIG. 7 shows the connecting regions of the airbag segments from FIG. 6 are glued to one another.

FIG. 8 shows a sectional diagram of the adhesive connection and connecting regions involved from FIG. 7.

FIG. 9 shows a further embodiment of an airbag device, wherein the airbag device is formed in the butterfly design and has adhesive connecting regions implemented offset to one another.

FIG. 10 shows the airbag device from FIG. 1 after the two airbag segments have been glued to one another, wherein two safety or positioning seams are also shown.

FIGS. 11-16 show production steps for producing a further embodiment of an airbag device, wherein two airbag segments, each having a slit-like opening, are provided and laid one above the other with a lateral overlap such that the openings are directly on above one another and sealed with an adhesive.

### DETAILED DESCRIPTION

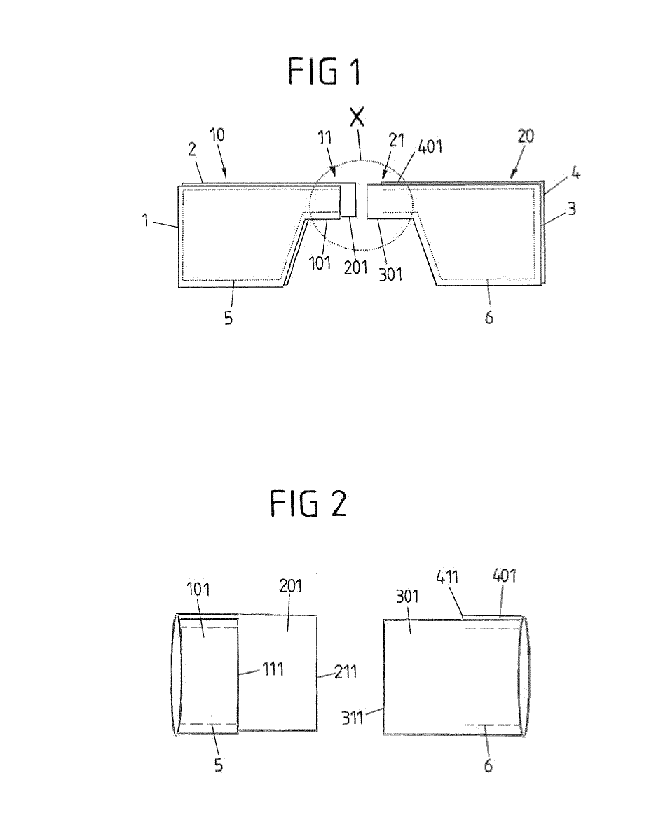

FIG. 1 shows an airbag device for a vehicle passenger-protecting system, comprising a first main fabric layer, which is formed by a material blank 1 from a first airbag segment 10 and a material blank 3 of a second airbag segment 20. The airbag device also has a second main fabric layer, which is formed by a material blank 2 from the first airbag segment 10 and a material blank 4 from the second airbag segment 20. In the embodiment shown here, the airbag device consists of an airbag to protect the head of a passenger, which airbag, in the assembled state, runs along the lateral structure of a vehicle, and thereby particularly covers the front and rear side windows with the two airbag segments 10, 20.

Both the first main fabric layer and the second main fabric layer thus comprise material blanks 1, 3 and 2, 4 which are pre-fabricated into the airbag segments 10, 20. In this case, material blanks 1, 2 are connected to one another by a gas-tight circumferential seam 5 on the edge, and material blanks 3, 4 are connected to one another by a gas-tight circumferential join 6 running along the edge. Provision is made, for example, to form the gas-tight circumferential seams 5, 6, for creating a silicon track between the material blanks in the seam region, through which seams 5, 6 run. Persons skilled in the art are familiar with gas-tight seams of this type.

Reference is made to the fact that, in the embodiment shown, the first main fabric layer is made only from two material blanks 1, 3, and the second main fabric layer is likewise made only from two material blanks 2, 4. Provision is made in alternative embodiments for a larger number of material blanks For example, provision can be made that material blank 1 itself may comprise a plurality of material blanks.

Reference is also made to the fact that, instead of using separate material layers 1, 2, 3, 4, the individual airbag segments 10, 20 can also be implemented in the butterfly design, wherein a one-piece material layer is folded in respect of an axis of symmetry or a folding edge, which e.g. runs along the upper edge of airbag segment 10, 20, wherein the fold defines the corresponding regions of the first main fabric layer and the second main fabric layer. The corresponding material parts are substantially identical in a butterfly design, i.e. mirror images of one another with respect to the axis of symmetry. The material layers in the respective material blanks thus quasi form the wings of a butterfly, which are formed as one single piece along the axis of symmetry. The one-piece material layer can then in turn be formed out of a plurality of material blanks which are glued to one another as explained below.

The further embodiments again refer to the embodiment of FIGS. 1, 2. Each of the two airbag segments 10, 20 has a hose-like region or channel 11, 21, which—in relation to the state of the airbag device in the state when installed in a vehicle—has a lower vertical expansion along the vertical vehicle axis than the remaining part of the airbag segment 10, 20. The hose-like regions 11, 21 of the two airbag segments 10, 20 are formed adjacent to one another.

The hose-like region 11 is formed by a material layer 101 of material blank 1 and a material layer 201 of material blank 2. The hose-like region 21 is formed by a material layer 301 of material blank 3 and a material layer 401 of material blank 4. These material layers 101, 201, 301, 401 are partial regions of the respective material blanks 1, 2, 3, 4.

Material layers 101, 201, 301, 401 of the respective regions 11, 21 are designed offset from one another, i.e. the front edges 111, 211, 311, 411 (hereinafter also designated as section edges) of the first main fabric layer and the second main fabric layer are not directly superimposed above one another in the first airbag section 10 or the second airbag section 10, but are instead offset behind one another. Correspondingly, material blanks 1, 2 of the main fabric layers lying opposite in region 11 and the material blanks 3, 4 of the main fabric layers lying opposite in region 21 are thus not designed identically, but rather differ from one another to provide the offset shown.

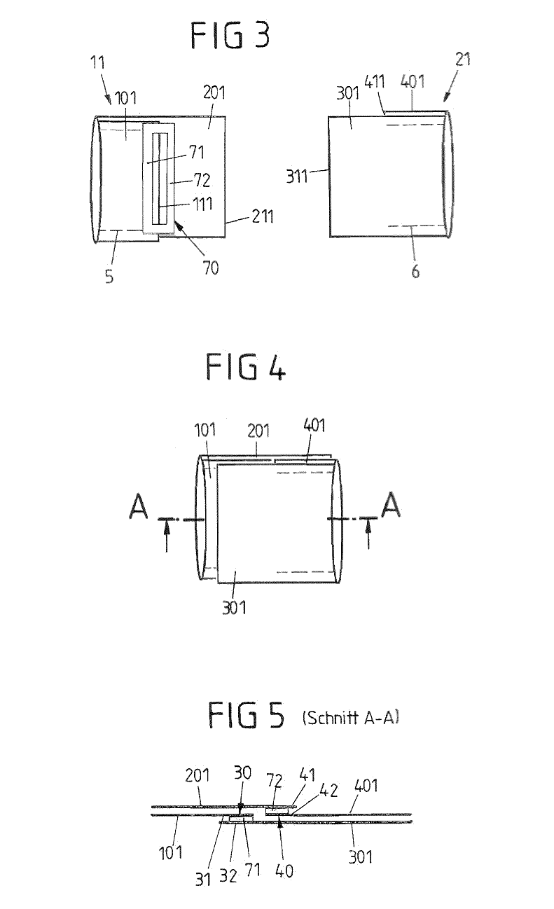

An advantage of this arrangement is that, after a connection of airbag segments 10, 20 (which is explained below) and a folding of the airbag device, no material accumulates at the connection point. Another advantage lies in the possibility of connecting the respective main fabric layers of both airbag segments 10, 20 to one another in just one process step, as shown below by way of FIGS. 3 to 8 by way of two embodiments.

According to FIG. 3, an adhesive is applied to an airbag segment 10 in its region 11. The adhesive is applied in the form of a ring 70, e.g. O-shaped or rectangular. The ring 70 forms an adhesive line 71, which is arranged on the outer side of material layer 101, thus adjacent to section edge 111. The ring 70 further forms an adhesive line 72 which runs substantially parallel to adhesive line 71 and is arranged on the inner side of the rear main fabric layer, namely the inner side of material layer 201.

To connect the two airbag segments 10, 20 according to FIG. 4, region 21 of the adjacent airbag segment 20 is applied on top of region 11 of airbag section 10. In doing so, section edge 311 of material layer 301 of the first main fabric layer rests on material layer 101 of the first main fabric layer. As shown in FIG. 5, this creates thereby a first overlapping region 30. In the first overlapping region 30, a connecting region 31 of material layer 101 of the first material blank 1 of the first main fabric layer is connected in an overlapping way with a connecting region 32 of material layer 301 of the material blank 3 of the first main fabric layer, wherein the adhesive providing the gas-tight connection runs between these connecting regions 31 and 32 and inside the overlapping region 30 in the form of adhesive line 71.

A second overlapping region 40 is likewise formed in a similar way, in that connecting region 41 of the material layer 201 of the material blank 2 of the second main fabric layer is connected to connecting region 42 of the material layer 401 of the material blank 4 of the second main fabric layer, wherein the adhesive runs in the overlapping region 40 as adhesive line 72.

The two overlapping regions 30, 40 are offset parallel to one another.

As the section edges 111, 211 of region 11 are mirror images of section edges 311, 411 of the other section 21, airbag segments 10, 20 can be connected to one another in one process step while simultaneously connecting material layers 201, 401 and material layers 101, 301, forming two offset overlapping regions 40, 30.

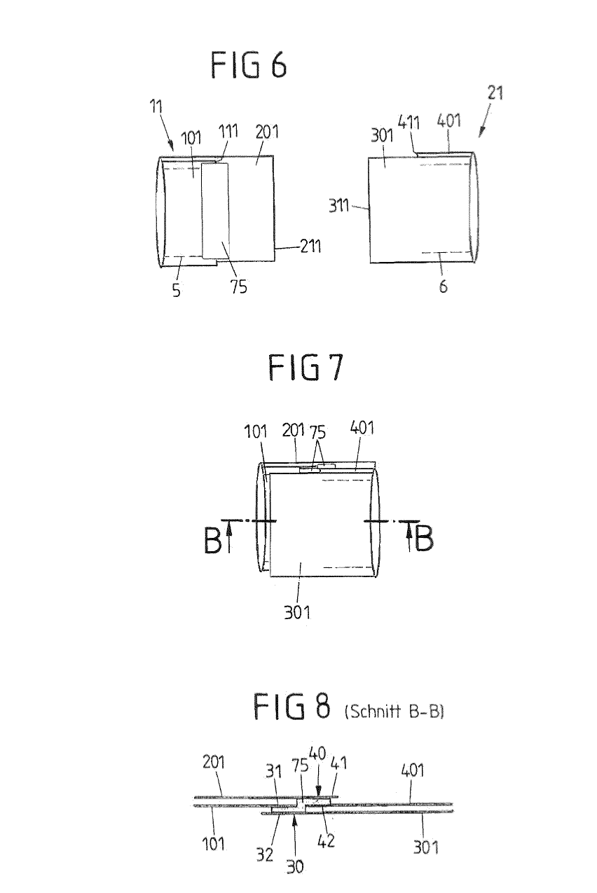

FIG. 6 shows a modification of the embodiment of FIG. 3, in which the adhesive is not formed in the shape of a ring 70, but rather spread flat as adhesive 75. Adhesive 75 covers a region of the outer side of material layer 101 of the first main fabric layer adjacent to section edge 111 as well as a part of the inner side of material layer 201 of the second main fabric layer.

Since the arrangement of section edges 111, 211, 311, 411 corresponds to the embodiment of FIG. 3, an adhesion and connection of airbag segments 10, 20 takes place according to the description in FIGS. 4 and 5.

As particularly visible in the sectional diagram in FIG. 8, this in turn creates two offset overlapping regions 30, 40, formed by connecting regions 31, 32 of material layers 101, 301, as well as by connecting regions 41, 42 of material layers 201, 401. Reference is made to the presentation in FIG. 5 for this.

Unlike the embodiment of FIGS. 3 to 5, the adhesive 75 also extends slightly out directly between the rear material layer 201 of the second main fabric layer and the front material layer 301 of the first main fabric layer. This is due to the fact that the front edges 111, 311 are not generally 100% flush with one another, due to tolerances.

However, the connection provided by the adhesive 75 between the rear main fabric layer and the front main fabric layer is ripped apart during inflation of the airbag device with gas during activation, which in turn creates the same situation as that shown in the embodiment in FIGS. 3 to 5.

Due to the hose-like regions 11, 21 in the two airbag segments 10, 20, these can be directly, i.e. without separate intermediate segments, connected to one another, wherein the regions 11, 21 connected to one another provide a filling channel through which the gas from a gas generator is fed into the two airbag segments 10, 20 during activation, and/or a connection channel.

A different provision can be made in an alternative embodiment that a separate airbag segment is used to provide a filling channel or a connection channel. This segment would be connected in a corresponding way to region 11 of airbag segment 10 and region 21 of the other airbag segment 20.

The adhesive used may be for example a silicon adhesive. Said adhesive can be applied in a viscous or in a paste-like and firm form in the form of a blank 70, 75 to a connecting region of the material blanks due to be connected.

The bonding process may be initiated or accelerated by applying contact pressure and/or heat. The adhesive used may be for example a 2-component silicon adhesive. Preferably, it is an adhesive with a short vulcanization time and which cures within 10 minutes or less, particularly within only one minute. In one embodiment, the adhesive used also has a minimum temperature below which no bonding process occurs. To initiate a bonding process, head must thus always be applied. For example, provision can be made that the adhesive only vulcanizes at temperatures above 130° C.

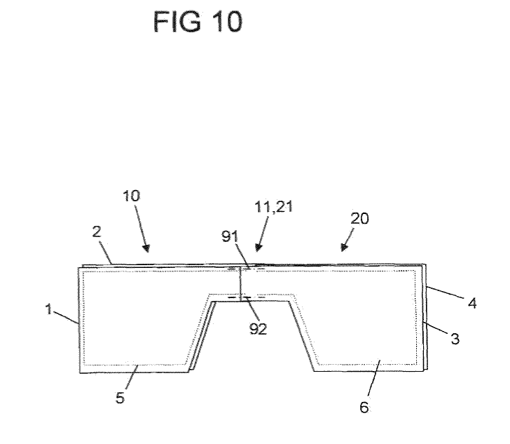

FIG. 10 shows the airbag device of FIGS. 1 and 2 after the two airbag segments 10, 20 have been glued together, e.g. as per FIGS. 3 to 5 or FIGS. 6 to 8.

Two optional safety or positioning seams 91, 92 are thereby additionally shown. These run for example along the lateral edge of the channel or connecting region provided by regions 11, 21. In one embodiment, these seams run substantially in the same direction as the adjacent circumferential seams 5, 6 of the two airbag segments 10, 20. It may also be that only one such seam is provided instead of two safety or positioning seams 91, 92.

In one example, seams 91, 92 are safety seams serving to additionally absorb any potential peeling forces in the transitional region 11, 21 between the airbag segments 10, 20. It must be noted here that circumferential seams 5, 6, which are designed to absorb peeling forces, are interrupted in the transitional region 11, 21. The additional safety seams 91, 92 provide extra safety and stability, particularly in the event of peeling forces.

In an alternative embodiment, seams 91, 92 are designed as positioning seams or guide seams during the production of the adhesive connection between the two airbag segments 10, 20. The positioning seams 91, 92 are applied before the adhesive used has completely cured. Positioning seams 91, 92 thus act as a type of pre-fastening before the adhesive bonds achieve the final fixity.

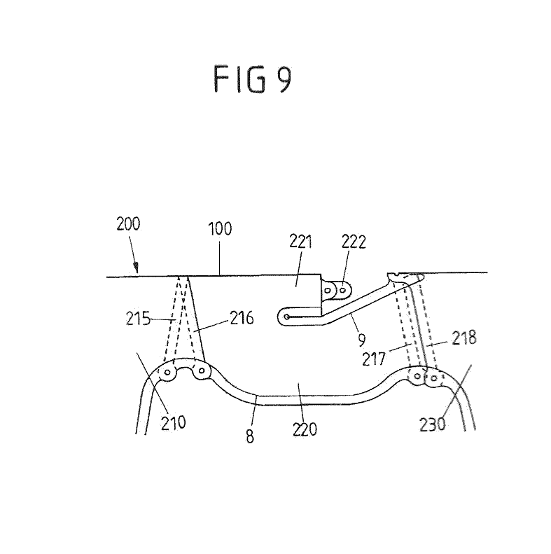

FIG. 9 shows another embodiment of an airbag device which has a first main fabric layer and a second main fabric layer. The airbag device shown has a butterfly design and is substantially symmetrical in respect of a folding edge 100. The airbag device comprises a one-piece airbag part 200 folded along the folding edge 100, by which means the first, front main fabric layer and the second, rear main fabric layer are defined. The airbag part 200 consists thereby of three material blanks, a first material blank 210, a second material blank 220 and a third material blank 230. The material blanks 210, 220, 230 are each glued to one another.

After halving or folding the airbag part 200 around the folding edge 100, the material blank 210 serves to form an airbag segment which, in the inflated state, creates an air cushion for a vehicle occupant to be protected. Material blank 230 likewise forms an airbag segment which, in the inflated state, creates an air cushion for a vehicle occupant to be protected. Material blank 220, which lies therebetween forms an airbag segment which provides a filling channel for the two other airbag segments and a receiving region 221 to receive and arrange a gas generator on the airbag device. To simplify insertion of a gas generator into the airbag section 221, clips 222 are provided, by means of which the receiving region 221 can be opened for simplified insertion of a gas generator. Additional gas-tight circumferential seams 8, 9, partially shown in FIG. 9, are also used to form the corresponding airbag segments.

As already mentioned, material blanks 210, 220, 230 are glued to one another before the halving or folding, as described in reference to FIGS. 1 to 8. The material blanks are thus adhesively connected to one another in a gas-tight manner in an overlapping region.

A completely symmetrical design of the airbag device would lead to the connecting regions of the respective material blanks 201, 220, 230 lying exactly superimposed on top of one another in the airbag folded along folding edge 100. As the connecting regions already lead to thickening due to the accompanying overlapping and thus to a certain amount of material accumulation at certain points after the airbag has been folded, this would be the case more than ever if, due to the butterfly design, two such connecting regions were to lie exactly on top of one another.

Provision is therefore made in the embodiment of FIG. 9 that the blanks 210, 220 and the connecting regions provided thereby for adhesive connection to the respective other blank, are designed such that, after folding along folding edge 100, two overlapping regions 215, 216 are provided, which do not lie on top of one another, but rather run at an angle to one another, and are shown as a V-shape in the embodiment.

With regards to the connection of material blanks 220, 230, provision is made that the material blanks 220, 230 designed such that the overlapping regions 217, 281 resulting from gluing are offset parallel to one another after folding along the folding edge 100. The parallel offset does not thereby lead to a leaky point, as circumferential seam 9 covers and seals the gap resulting from the parallel offset.

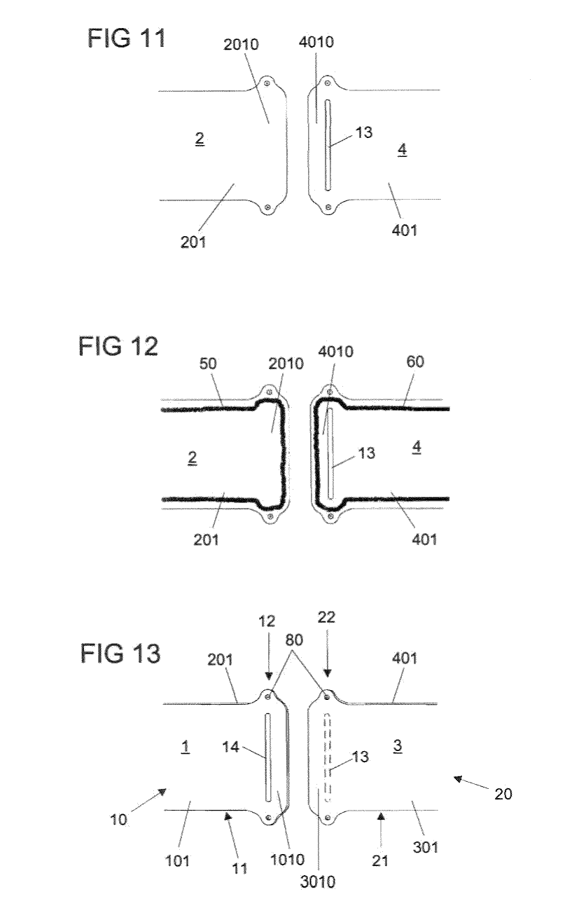

A further embodiment of an airbag device is described below by way of FIGS. 11 to 16, which show the process steps for producing the further embodiment.

According to FIG. 11, two material blanks 2, 4 are initially provided, which form parts of different, adjacent airbag segments in the finished airbag. Material blank 2 forms a material layer 201 and material blank 4 a material layer 401. The two material layers 201, 401 each form a region 2010, 4010 at the front which is provided to form a connecting region between two airbag segments, as will be explained later.

An elongated slit 13 is formed in material layer 401 in region 4010, which slit 13 runs substantially parallel to the adjacent front side circumferential edge of the material layer 401. In the assembled airbag device, the slit 13 serves to provide an opening for gas to flow into the airbag segment or out of the same. Slit 13 thus preferably has a minimum width to enable a safe gas flow. Fundamentally, however, the opening formed by slit 13 can also be created in another way, e.g. as an incision in material layer 401 or through a different-shaped opening, e.g. an oval or circular opening.

According to FIG. 12, a silicon track 50, 60 is applied along the edge region of the material layers 201, 401. The silicon track runs thereby continuously along the edge region of the material layers 201, 401.

According to FIG. 13, a material blank 1 is subsequently placed on material blank 2, and material blank 3 on material blank 4. The material layers 1, 2 and 3, 4 are connected to one another in a gas-tight manner at the silicon tracks 50, 60.

Material blank 1 has thereby a material layer 101, whose shape corresponds with material layer 201 of material blank 2. In the same way, material blank 3 has a material layer 301, whose shape and dimensions correspond with material layer 401 of material blank 4. Unlike the embodiment in FIGS. 1 to 8, the material layers 101, 201 and 301, 401 do not have a front offset. To accurately align material layers 101, 201, 301, 401, provision can be made for guide holes 80 at the corresponding point in the individual material layers 101, 201, 301, 401.

Further, material layers 101, 301 have, like material layers 201, 401, front regions 1010, 3010 which provide a connecting region between the airbag segments 10, 20 formed by material layers 1, 2 and 3, 4. An elongated slit 14 is arranged in the material layer 101 in the region 1010, which slit 14 corresponds in dimensions and alignment with slit 13 of material layer 401. However, slit 14 is located in the upper material blank 1 of the two material blanks 1, 2, while slit 13 is located in the lower material blank 4 of the two material blanks 3, 4.

The material layers 101, 201 and 301, 401 shown in FIGS. 11 to 13 are partial regions of material blanks 1, 2, 3, 4, and thus partial regions which form hose-shaped regions or channels 11, 21, cf. FIG. 13. The material blanks 1, 2 and 3, 4 each form an airbag segment 10, 20 in which the hose-shaped regions 11, 21 each constitute a partial region which—in relation to the state of the airbag device in the state when installed in a vehicle—has a lower vertical expansion than the remaining part of the respective airbag segment 10, 20. The remaining part of the respective airbag segment 10, 20 is designed, for example, corresponding to FIG. 1.

In the hose-shaped regions 11, 12, the front regions 1010, 2010 of the first and the second material blanks 1, 2 form a transitional section 12 of the first airbag segment 10. In the same way, regions 3010, 4010 of the material blanks 3, 4 form a transitional section 22 of the second airbag segment 20. As explained in more detail later, the transitional sections 12, 22 are connected to one another such that a transitional section is created in which the two airbag segments 10, 20 are connected to one another in a gas-tight manner.

As can be seen in FIG. 13, the slit 14 of the airbag segment 10 is arranged above, thus uncovered, while the slit 13 of the airbag segment 20 is covered by material layer 301.

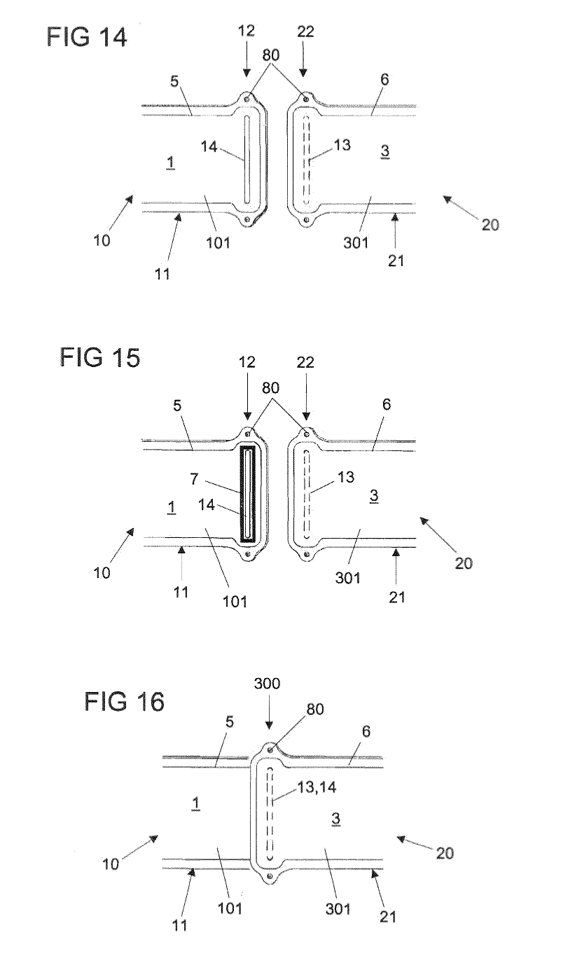

Further processing must wait to proceed until the silicon tracks 50, 60 are cured. Subsequently, as shown in FIG. 14, a seam 5, 6 is then set in the silicon tracks 50, 60, by means of which material blanks 1, 2 and 3, 4 are firmly connected to one another at the edge thereof. Forming the circumferential seams 5, 6 in the silicon tracks 50, 60 ensures that the seams 5, 6 are gas-tight.

As per FIG. 15, the next process step is to apply an adhesive 7 to material layer 101 around the opening 14. The adhesive is formed in the shape of a closed ring, e.g. an oval or rectangle. The adhesive 7 completely surrounds the opening 14 without interruption. In one embodiment, the adhesive 7 is a paste-like blank of adhesive compound which is laid around the opening 14.

In the last process step, according to FIG. 16, the two pre-fabricated airbag segments 10, 20 are joined together and glued to one another in one step. When the airbag is laid out flat, as shown in FIGS. 11 to 16, the transitional section 22 of the second airbag segment 20 is thereby laid laterally overlapping the transitional section 12 of the first airbag segment 10. The two transitional sections 12, 22 and the regions forming said sections are arranged superimposed on top of one another, wherein the regions 2010, 1010, 4010, 3010 lie on top of one another in this sequence when the airbag is laid out flat. An exact alignment of said regions and the transitional sections 12 22 formed thereby can in turn result via the pilot holes 80.

The lateral joining of the two airbag segments 10, 20, achieves that the opening 14 formed in the transitional section 12 of the first airbag segment 10, and the opening 13 formed in the transitional section 22 of the second airbag segment 20 come to lie directly on top of one another, wherein opening 13 is arranged in material layer 401 above opening 14 in material layer 101. Both openings or slits 13, 14 are thus aligned exactly on top of one another. At the same time, adhesive 7 ensures that the flow channel formed by the two openings 13, 14 between airbag segments 10, 20 is sealed. The adhesive 7 glues the two openings 13, 14 to one another such that the material blanks 101 and 401, containing the respective openings 14, 13, are connected with one another adjacent to the openings 14, 13.

Similar to the description relating to FIGS. 1 to 18, the adhesive used is, for example, a silicon adhesive. Said adhesive can be applied in a viscous or paste-like, firm form as a blank. An initiation or acceleration of the bonding process can result from the application of contact pressure and/or heat. The adhesive used is, for example, a 2-component silicon adhesive. Preferably, an adhesive is used which has a short vulcanization time and which cures within 10 minutes or less, particularly within just 1-2 minutes. In addition, in one embodiment, the adhesive used has a minimum temperature below which no bonding process can take place. Heat must thus always be applied in order to initiate the bonding process. Provision can be made, for example, that the adhesive only vulcanizes at temperatures above 130° C.

Provision can be made in one embodiment that the two airbag segments 10, 20 connected in transitional region 300 be additionally secured with optional safety and positioning seams (not shown). These may run for example along the lateral edge of the channel or connecting region provided by regions 11, 21. In particular, these safety and positioning seams run substantially in the same direction in one embodiment as the adjacent circumferential seams 5, 6 of the two airbag segments 10, 20. By this means, the transitional region 300 is additionally secured.

In the event that the airbag segments 10, 20 are filled with gas, the transitional region 300 is inflated, wherein the slit-shaped openings 13, 14 are bent in an approximately elliptical or circular shape, such that an elliptical or circular flow channel is created which connects the airbag segments 10, 20 to one another.

With respect to the embodiment described in FIGS. 11 to 16, two airbag segments 10, 20 are thus joined in one process step, without the need for a stitching process, to provide a connection channel between the two airbag segments 10, 20. The join direction is lateral in the sense that the two transitional sections 12, 22 of airbag segments 10, 20 are laid one above the other with a lateral overlap with respect to the plane of extension of the airbag when the latter is laid out flat, wherein the respective openings 14, 13 formed in the transitional sections 12, 22 come to be directly on top of one another in the arrangement.

Reference is further made to the fact that the transitional region 300 is designed symmetrically insofar as the two transitional sections 12, 22 are mirror-symmetric with respect to the plane in which the adhesive 7 is formed. This allows the transitional sections 12, 22 to be designed in a standardized and uniform manner in otherwise randomly shaped airbag segments, such that defined interfaces to connect airbag segments can be provided.

The invention is not limited in configuration to the embodiments shown above, which are to be understood merely as examples. For example, provision can be alternately made in the embodiment in FIG. 9 that the airbag device is not designed in a butterfly design and correspondingly is provided with two material blanks of a type which are connected to one another on the circumferential side, as per FIG. 1, instead of having a material blank 210, 220, 230. Further, the shapes and processes shown, as well as the airbags, material blanks, and adhesive connections, are also only to be understood as examples.

The priority application, German Patent Application Number 10 2009 055 029.1, filed Dec. 18, 2009 is incorporated by reference herein.

1. An airbag device for a vehicle passenger-protecting system comprising:
a first airbag segment, having at least two material blanks, and
a second airbag segment having at least two material blanks, wherein
the material blanks of the first airbag segment and the material blanks of the second airbag segment are connected to one another at the respective circumferential edge in a gas-tight manner,
the first airbag segment has a first transitional section and the second airbag segment has a second transitional section, wherein the transitional sections form a transitional region in which the two airbag segments are connected to one another in a gas-tight manner, and wherein
an opening is formed in each of the two transitional sections, wherein the two transitional sections lie one above the other with a lateral overlap with respect to the plane of extension of the airbag when the latter is laid out flat and are connected by an adhesive such that the opening formed in the first transitional section and the opening formed in the second transitional section form a sealed flow channel between the two airbag segments.

2. The airbag device according to claim 1, wherein the two transitional sections lie superimposed one over the other with a lateral overlap such that the opening formed in the first transitional section and the opening formed in the second transitional section lie directly superimposed one over the other and are thereby sealed by the adhesive.

3. The airbag device according to claim 1, wherein the openings are respectively formed in one of the material blanks of the respective airbag segments.

4. The airbag device according to claim 3, wherein when the airbag is laid out flat, the opening is formed by a slit or incision in a material blank.

5. The airbag device according to claim 1, wherein when the airbag is laid out flat, the transitional region comprises the following:
a first and a second material blank of the first airbag segment, wherein the first material blank has a first region and the second material blank a second region, which regions are placed superimposed one on top of the other and are connected to one another at the circumferential edge in a gas-tight manner, and wherein an opening in the material blank is formed in the upper of the two regions,
a third and a fourth material blank of the second airbag segment, wherein the third material blank has a third region and the fourth material blank has a fourth region, which regions are placed superimposed one on top of the other and are connected to one another at the circumferential edge in a gas-tight manner, and wherein an opening in the material blank is formed in the lower of the two regions,
wherein the four regions of the two airbag segments are arranged superimposed one above the other in the transitional region such that the opening in the lower of the two regions of the second airbag segment is arranged above the opening in the upper of the two regions of the first airbag segment.

6. The airbag device according to claim 1, wherein the two airbag segments, with respect to the plane of extension of the airbag when the latter is laid out flat, have two fabric layers with offset ends in the transitional section and by means of lateral joining, two such fabric layers are laid one above the other with a lateral overlap and are connected to one another in an overlapping region, wherein in each case two fabric layers connected in such a way form one of the main fabric layers of the airbag.

7. The airbag device according to claim 1, wherein at least one of the airbag segments forms a hose-like region which—in relation to the state of the airbag device in the state when installed in a vehicle—has a lower vertical expansion along the vertical vehicle axis than the remaining part of the airbag segment under consideration, and the transitional sections 2) are formed in the hose-like region.

8. An airbag device for a vehicle passenger-protection system, comprising
a first main fabric layer which, in the inflated state of the airbag device, faces towards one or more of the persons to be protected,
a second main fabric layer which, in the inflated state of the airbag device, lies opposite the first main fabric layer, wherein
the first main fabric layer and the second main fabric layer are connected to one another at their respective circumferential edges in a gas-tight manner, or form a butterfly design having at least one folding edge and one gas-tight connecting region on the edge,
the two main fabric layers comprise several separate material blanks, wherein
with respect to the two main fabric layers, at least one of the material blanks has at least one connecting region which overlaps a connecting region of another material blank of the same main fabric layer, wherein the material blanks in the overlapping region are exclusively connected to one another in a gas-tight manner via an adhesive, and wherein at least one overlapping region of the first main fabric layer is offset from and/or runs at an angle to all overlapping regions of the second main fabric layer.

9. The airbag device according to claim 8, wherein the first and the second main fabric layers form at least two pre-fabricated, inflatable airbag segments separated from one another which segments are glued to one another in a gas-tight manner, wherein the one airbag segment forms a first connecting region of the first main fabric layer, and offset therefrom a second connecting region of the second main fabric layer, the other airbag segment forms a third connecting region of the first main fabric layer and offset therefrom a fourth connecting region of the second main fabric layer, and the two connecting regions of a main fabric layer are adhesively connected to one another.

10. The airbag device according to claim 1, wherein the transitional sections of the two airbag segments have a safety or positioning seam.

11. The airbag device according to claim 1, wherein the adhesive is fast setting and cures within 10 minutes or less, particularly within 1 minute.

12. The airbag device according to claim 1, wherein the adhesive is formed by a paste-like blank of adhesive compound, wherein the blank is applied to one of the relevant connecting regions prior to gluing.

13. The airbag device according to claim 1, wherein the adhesive is formed such that a bonding is initiated or accelerated by applying pressure and/or heat.

14. A method for producing an airbag device according to claim 1, comprising the following steps:
connecting two material blanks to form a first inflatable airbag segment, wherein a first opening is introduced in one of the material blanks in a region forming a transitional section of the airbag segment, through which opening gas can flow into or out of the first airbag segment,
connecting two further material blanks to form a second inflatable airbag segment, wherein a second opening is introduced in one of the material blanks in a region forming a transitional section of the airbag segment, through which opening gas can flow into or out of the second airbag segment,
connecting of the first and the second airbag segments by means of an adhesive, wherein the transition sections of the two airbag segments are laid one above the other with a lateral overlap with respect to the plane of extension of the airbag when the latter is laid flat, such that the openings formed in the two airbag segments form a flow channel.

15. The method according to claim 14, wherein the openings are formed as slits or incisions in the respective material blank.
